(19) United States
(12) Patent Application Publication
(10) Pub. No.: US 2018/0058967 A1
(43) Pub. Date: Mar. 1, 2018

(54) METHOD FOR PROVIDING LOCATION INFORMATION OF AN EXTERNAL DEVICE AND ELECTRONIC DEVICE THEREOF

(71) Applicant: Samsung Electronics Co., Ltd., Gyeonggi-do (KR)

(72) Inventors: Ji Hoon Jang, Yongin-si (KR); Du Seok Kim, Yongin-si (KR); Younghyun Kim, Gunpo-si (KR); Suneung Park, Seoul (KR); Dongju Lee, Suwon-si (KR)

(21) Appl. No.: 15/678,006

(22) Filed: Aug. 15, 2017

(30) Foreign Application Priority Data
Aug. 23, 2016 (KR) 10-2016-0106736

(51) Int. Cl. G01L 19/08

(52) U.S. Cl. CPC G01L 19/086

(57) ABSTRACT

Various exemplary embodiments of the present invention relate to an apparatus and method for providing location information of an external device by an electronic device. In this case, the electronic device includes an air pressure sensor, a display, and a processor. The processor may be configured for identifying air pressure of an external device, detecting air pressure of a region in which the electronic device is located by using the air pressure sensor. The processor may also be configured for detecting a direction in which the external device is located based on a difference between the air pressure of the external device and the air pressure of the region in which the electronic device is located. The processor may also be configured for controlling the display to display the direction in which the external device is located. Other exemplary embodiments may also be possible.

### CROSS-REFERENCE TO RELATED APPLICATION(S) AND CLAIM OF PRIORITY

This application is related to and claims priority to Korean Patent Application No. 10-2016-0106736 filed on Aug. 23, 2016, the contents of which are incorporated herein by reference.

### TECHNICAL FIELD

Various exemplary embodiments of the present invention relate to an apparatus and method for providing location information of an external device by an electronic device.

### BACKGROUND

An electronic device may identify a location of an external device (e.g., a vehicle, another electronic device) by using satellite communication and wireless communication networks. For example, the external device may identify the location of the external device by using a satellite signal received from a satellite through a satellite reception module. The electronic device may acquire location information of the external device from the external device through the wireless communication network. The electronic device may output the location information of the external device so that a user can identify the location information. For example, the external device may include a vehicle control device equipped in the vehicle.

When an external device is located inside or underground of a building such as a shopping center or a department store, location detection of the external device by using a satellite signal may be limited since the satellite signal cannot be received. Accordingly, there may be a problem in that an electronic device cannot identify the location of the external device located inside the building or located underground thereof by using a Global Navigation Satellite System (GNSS).

In addition, the GNSS cannot detect the location of the external device in a vertical space. Accordingly, there may be problem in that the electronic device cannot accurately identify the location (e.g., a floor) of the external device located inside the building by using the GNSS.

### SUMMARY

To address the above-discussed deficiencies, it is a primary object to provide an apparatus and method for identifying location information of an external device by an electronic device.

According to various exemplary embodiments of the present invention, an electronic device includes an air pressure sensor, a display, and a processor. The processor may be configured for identifying air pressure of an external device, detecting air pressure of a region in which the electronic device is located by using the air pressure sensor, detecting a direction in which the external device is located based on a difference between the air pressure of the external device and the air pressure of the region in which the electronic device is located, and controlling the display to display the direction in which the external device is located.

According to various exemplary embodiments of the present invention, a method of operating an electronic device includes identifying air pressure of an external device, detecting air pressure of a region in which the electronic device is located, detecting a direction in which the external device is located based on a difference between the air pressure of the external device and the air pressure of the region in which the electronic device is located, and controlling the display to display the direction in which the external device is located.

Before undertaking the DETAILED DESCRIPTION below, it may be advantageous to set forth definitions of certain words and phrases used throughout this patent document: the terms “include” and “comprise,” as well as derivatives thereof, mean inclusion without limitation; the term “or,” is inclusive, meaning and/or; the phrases “associated with” and “associated therewith,” as well as derivatives thereof, may mean to include, be included within, interconnect with, contain, be contained within, connect to or with, couple to or with, be communicable with, cooperate with, interleave, juxtapose, be proximate to, be bound to or with, have, have a property of, or the like; and the term “controller” means any device, system or part thereof that controls at least one operation, such a device may be implemented in hardware, firmware or software, or some combination of at least two of the same. It should be noted that the functionality associated with any particular controller may be centralized or distributed, whether locally or remotely.

Moreover, various functions described below can be implemented or supported by one or more computer programs, each of which is formed from computer readable program code and embodied in a computer readable medium. The terms “application” and “program” refer to one or more computer programs, software components, sets of instructions, procedures, functions, objects, classes, instances, related data, or a portion thereof adapted for implementation in a suitable computer readable program code. The phrase “computer readable program code” includes any type of computer code, including source code, object code, and executable code. The phrase “computer readable medium” includes any type of medium capable of being accessed by a computer, such as read only memory (ROM), random access memory (RAM), a hard disk drive, a compact disc (CD), a digital video disc (DVD), or any other type of memory. A “non-transitory” computer readable medium excludes wired, wireless, optical, or other communication links that transport transitory electrical or other signals. A non-transitory computer readable medium includes media where data can be permanently stored and media where data can be stored and later overwritten, such as a rewritable optical disc or an erasable memory device.

Definitions for certain words and phrases are provided throughout this patent document, those of ordinary skill in the art should understand that in many, if not most instances, such definitions apply to prior, as well as future uses of such defined words and phrases.

### BRIEF DESCRIPTION OF THE DRAWINGS

For a more complete understanding of the present disclosure and its advantages, reference is now made to the following description taken in conjunction with the accompanying drawings, in which like reference numerals represent like parts:

FIG. 1 illustrates a structure of a system for identifying a location of an external device by using air pressure information according to various exemplary embodiments of the present invention;

FIG. 2 illustrates a block diagram of an electronic device in a network environment according to various exemplary embodiments of the present invention;

FIG. 3 illustrates a block diagram of an electronic device according to various exemplary embodiments of the present invention;

FIG. 4 illustrates a block diagram of an external device according to various exemplary embodiments of the present invention;

FIG. 5 illustrates a flowchart for detecting a direction of an external device by using air pressure information by an electronic device according to various exemplary embodiments of the present invention;

FIG. 6 illustrates a configuration for identifying a floor of a building by using air pressure information by an electronic device according to various exemplary embodiments of the present invention;

FIGS. 7A to 7C illustrate a screen configuration for displaying a direction of an external device by an electronic device according to various exemplary embodiments of the present invention;

FIG. 8 illustrates a flowchart for identifying air pressure information of an external device by an electronic device according to various exemplary embodiments of the present invention;

FIGS. 9A to 9D illustrate air pressure graphs according to various exemplary embodiments of the present invention;

FIG. 10 illustrates a flowchart for acquiring air pressure information of a parked vehicle by an electronic device according to various exemplary embodiments of the present invention;

FIG. 11 illustrates a configuration for determining whether being placed in a vehicle by an electronic device according to various exemplary embodiments of the present invention;

FIG. 12 illustrates a flowchart for periodically detecting a direction of an external device by an electronic device according to various exemplary embodiments of the present invention;

FIG. 13 illustrates a flowchart for transmitting air pressure information by an external device according to various exemplary embodiments of the present invention; and

FIG. 14 illustrates a flowchart for transmitting air pressure information of a parking location by an external device according to various exemplary embodiments of the present invention.

### DETAILED DESCRIPTION

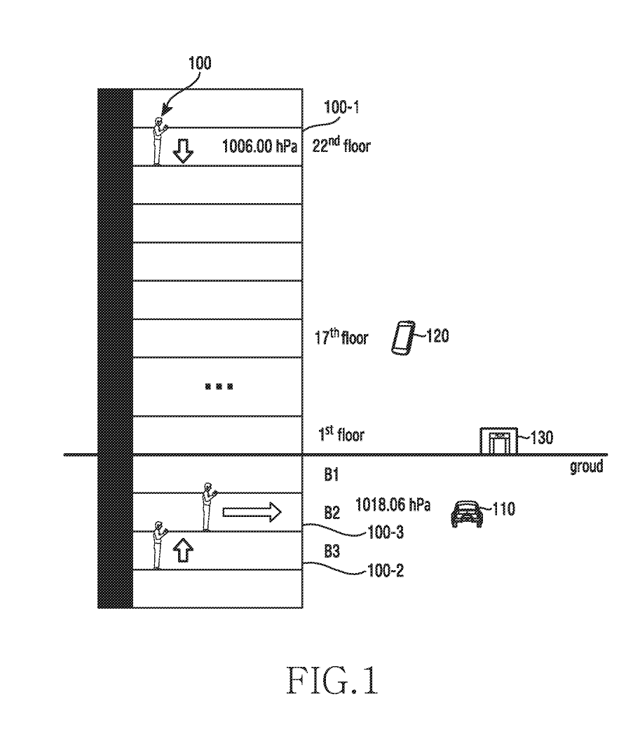

FIGS. 1 through 14, discussed below, and the various embodiments used to describe the principles of the present disclosure in this patent document are by way of illustration only and should not be construed in any way to limit the scope of the disclosure. Those skilled in the art will understand that the principles of the present disclosure may be implemented in any suitably arranged system or device.

In the present document, an expression “A or B”, “A and/or B”, or the like may include all possible combinations of items enumerated together. Although expressions such as “1st”, “2nd”, “first”, and “second” may be used to express corresponding constitutional elements, it is not intended to limit the corresponding constitutional elements. When a certain (e.g., 1st) constitutional element is mentioned as being “operatively or communicatively coupled with/to” or “connected to” a different (e.g., 2nd) constitutional element, the certain constitutional element is directly coupled with/to another constitutional element or can be coupled with/to the different constitutional element via another (e.g., 3rd) constitutional element.

An expression “configured to” used in the present document may be interchangeably used with, for example, “suitable for”, “having the capacity to”, “adapted to”, “made to”, “capable of”, or “designed to” in a hardware or software manner according to a situation. In a certain situation, an expressed “a device configured to” may imply that the device is “capable of” together with other devices or components. For example, “a processor configured to perform A, B, and C” may imply a dedicated processor (e.g., an embedded processor) for performing a corresponding operation or a generic-purpose processor (e.g., Central Processing Unit (CPU) or an application processor) capable of performing corresponding operations by executing one or more software programs stored in a memory device.

An electronic device according to various embodiments of the present disclosure, for example, may include at least one of a smartphone, a tablet personal computer (PC), a mobile phone, a video phone, an electronic book (e-book) reader, a desktop PC, a laptop PC, a netbook computer, a workstation, a server, a personal digital assistant (PDA), a portable multimedia player (PMP), an MP3 player, a mobile medical appliance, a camera, and a wearable device (e.g., smart glasses, a head-mounted-device (HMD), electronic clothes, an electronic bracelet, an electronic necklace, an electronic accessory, an electronic tattoo, a smart mirror, or a smart watch).

According to some embodiments, the electronic device (ex. home appliance) may include at least one of, for example, a television, a Digital Video Disk (DVD) player, an audio, a refrigerator, an air conditioner, a vacuum cleaner, an oven, a microwave oven, a washing machine, an air cleaner, a set-top box, a home automation control panel, a security control panel, a TV box (e.g., Samsung HomeSync®, Apple TV®, or Google TV®), a game console (e.g., Xbox® and PlayStation®), an electronic dictionary, an electronic key, a camcorder, and an electronic photo frame.

According to another embodiment, the electronic device may include at least one of various medical devices (e.g., various portable medical measuring devices (a blood glucose monitoring device, a heart rate monitoring device, a blood pressure measuring device, a body temperature measuring device, etc.), a Magnetic Resonance Angiography (MRA), a Magnetic Resonance Imaging (MRI), a Computed Tomography (CT) machine, and an ultrasonic machine), a navigation device, a Global Positioning System (GPS) receiver, an Event Data Recorder (EDR), a Flight Data Recorder (FDR), a Vehicle Infotainment Devices, an electronic devices for a ship (e.g., a navigation device for a ship, and a gyro-compass), avionics, security devices, an automotive head unit, a robot for home or industry, an automatic teller's machine (ATM) in banks, point of sales (POS) in a shop, or internet device of things (e.g., a light bulb, various sensors, electric or gas meter, a sprinkler device, a fire alarm, a thermostat, a streetlamp, a toaster, a sporting goods, a hot water tank, a heater, a boiler, etc.).

According to some embodiments, the electronic device may include at least one of a part of furniture or a building/structure, an electronic board, an electronic signature receiving device, a projector, and various kinds of measuring instruments (e.g., a water meter, an electric meter, a gas meter, and a radio wave meter). The electronic device according to various embodiments of the present disclosure may be a combination of one or more of the aforementioned various devices. The electronic device according to some embodiments of the present disclosure may be a flexible device (or foldable device). Further, the electronic device according to an embodiment of the present disclosure is not limited to the aforementioned devices, and may include a new electronic device according to the development of technology

Hereinafter, an electronic device according to various embodiments will be described with reference to the accompanying drawings. As used herein, the term “user” may indicate a person who uses an electronic device or a device (e.g., an artificial intelligence electronic device) that uses an electronic device.

According to various exemplary embodiments of the present document, an external device may include another electronic device configured equally to an electronic device or a vehicle control device for controlling a vehicle.

FIG. 1 illustrates a structure of a system for identifying a location of an external device by using air pressure information according to various exemplary embodiments of the present invention.

Referring to FIG. 1, an electronic device 100 may compare air pressure information of the electronic device 100 and air pressure information of an external device 110, 120, or 130, to detect a direction in which the external device 110, 120, or 130, is located.

According to one exemplary embodiment, if the electronic device 100 is located in a first place 100-1 (e.g., a 22nd floor) inside a building, a direction (e.g., a downward direction) in which the vehicle 110 is located may be output based on a difference between air pressure (e.g., 1006 hPa) of the electronic device 100 and air pressure (e.g., 1018.06 hPa) of the vehicle 110. For example, the electronic device 100 may estimate the direction in which the vehicle 110 is located by using air pressure information of the vehicle 110 acquired at a time of parking the vehicle 110. For example, upon occurrence of an event for a location guidance, the electronic device 100 may transmit an air pressure request signal to the vehicle 110. The electronic device 100 may estimate a direction in which the vehicle 110 is located by using the received air pressure information of the vehicle 110 in response to the air pressure request signal. For example, the vehicle 110 may include a vehicle control device equipped in the vehicle 110.

According to one exemplary embodiment, if the electronic device 100 is located in a second place 100-2 (e.g., a 3rd basement level B3) inside the building, a direction (e.g., an upward direction) in which the vehicle 110 is located may be output based on the difference between the air pressure (e.g., 1019.1 hPa) of the vehicle 110 and the air pressure (e.g., 1018.06 hPa) of the vehicle 110. For example, the electronic device 100 may persistently or periodically detect the direction in which the vehicle 110 is located based on the difference between the air pressure of the electronic device 100 and the air pressure of the vehicle 110. If the direction in which the vehicle 110 is located is changed, the electronic device 100 may output information of the changed location. For example, the electronic device 100 may persistently or periodically detect the direction in which the vehicle 110 is located by using air pressure information periodically updated by the vehicle 110 for the vehicle 110. For example, a period for detecting the direction in which the vehicle 110 is located may be set differently based on a movement means of the electronic device 100. For example, the vehicle 110 may dynamically set an air pressure information update period of the vehicle 110 based on weather of a region in which the vehicle 110 is located.

According to one exemplary embodiment, if it is determined that the electronic device 100 is located in the same floor 100-3 (e.g., a 2nd basement level B2) as the vehicle 110 based on the difference between the air pressure of the electronic device 100 and the air pressure of the vehicle 110, the electronic device 100 may output arrival information. For example, when the difference between the air pressure of the electronic device 100 and the air pressure of the vehicle 110 is within a reference range (e.g., 0.9 hPa), the electronic device 100 may determine that the electronic device 100 is located in the same floor as the vehicle 110. Additionally or alternatively, the electronic device 100 may terminate a location guidance service of the vehicle 110.

According to one exemplary embodiment, if the electronic device 100 is located in the first place 100-1 (e.g., a 22nd floor) inside the building, a direction (e.g., a downward direction) in which the external electronic device 120 is located may be output based on the air pressure of the electronic device 100 and the air pressure of the external electronic device 120. For example, upon detection of an event occurrence for a location guidance, the electronic device 100 may transmit an air pressure request signal to the external electronic device 120. The external electronic device 120 may identify whether the electronic device 100 can be authenticated in response to reception of the air pressure request signal. Upon authentication of the electronic device 100, the external electronic device 120 may transmit air pressure information of the external electronic device 120 to the electronic device 100. The electronic device 100 may estimate the direction in which the external electronic device 120 is located by using the air pressure information of the external electronic device 120. For example, if the electronic device 100 is included in a location sharing list of the external electronic device 120, the external electronic device 120 may determine that the electronic device 100 is authenticated. For example, if the air pressure request signal includes disaster information, the external electronic device 120 may skip the authentication procedure of the electronic device 100.

According to one exemplary embodiment, if the electronic device 100 is located in the second place 100-2 (e.g., a 3rd basement level) inside the building, a direction (e.g., an upward direction) in which the shop 130 is located may be output based on the difference between the air pressure of the electronic device 100 and the air pressure of the shop 130. For example, the electronic device 100 may transmit an air pressure request signal to a location management device located in the shop 130 by using an application related to the shop 130. In response to reception of the air pressure request signal, the location management device may measure the air pressure of the shop 130 and transmit it to the electronic device 100. The electronic device 100 may estimate the direction in which the shop 130 is located by using air pressure information of the shop 130. For example, upon authentication of the electronic device 100 by using a membership management list, the location management device may transmit the air pressure information of the shop 130 to the electronic device 100.

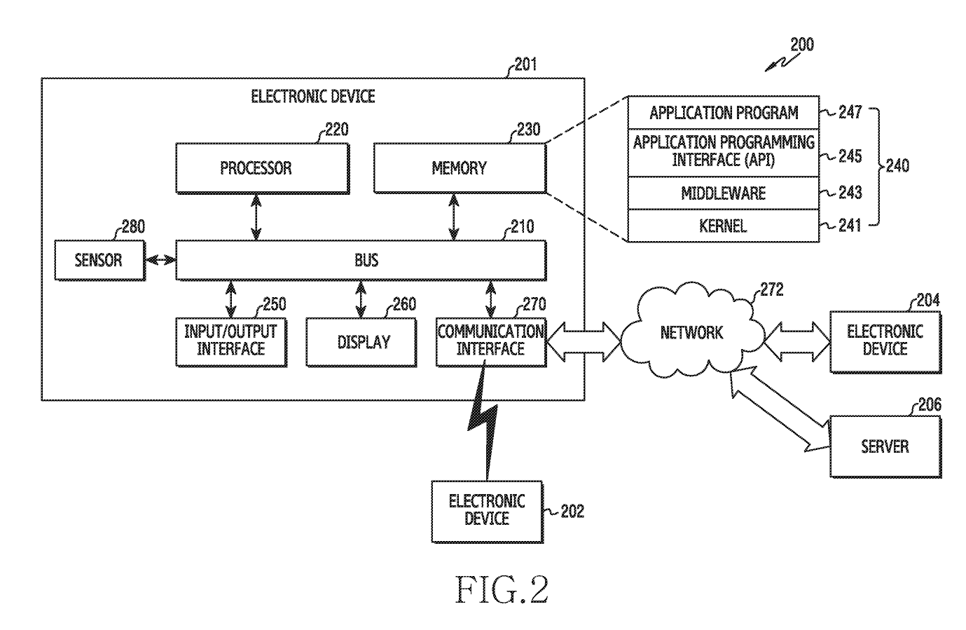

FIG. 2 is a block diagram of an electronic device 201 in a network environment 200 according to various exemplary embodiments of the present invention. In the following description, the electronic device 201 may include all or some parts of the electronic device 101 of FIG. 1.

Referring to FIG. 2, the electronic device 201 may include constitutional elements including a bus 210, a processor 220 (e.g., including processing circuitry), a memory 230, an input/output interface 250 (e.g., including input/output circuitry), a display 260 (e.g., including display circuitry), a communication interface 270 (e.g., including communication circuitry), and a sensor 280. In a certain exemplary embodiment, the electronic device 201 may omit at least one of the constitutional elements or may additionally include other constitutional elements.

The bus 210 may include a circuit for connecting, for example, the constitutional elements 220 to 280 to each other and for delivering communication (e.g., a control message and/or data) between the aforementioned constitutional elements.

The processor 220 may include one or more of a Central Processing Unit (CPU), an Application Processor (AP), and a Communication Processor (CP). For example, the processor 220 may execute an arithmetic operation or data processing for control and/or communication of different constitutional elements of the electronic device 201.

According to one exemplary embodiment, the processor 220 may detect a direction (e.g., an upward/downward direction) in which the external device is located based on a difference between air pressure of the electronic device 201 and air pressure of the external device. For example, if the memory 230 has reliable air pressure information stored therein for the external device, the processor 220 may estimate the direction in which the external device is located based on the difference between the air pressure measured by the sensor 280 for the electronic device 201 and the air pressure, stored in the memory 230, for the external device. For example, the processor 220 may estimate the direction in which the external device is located based on the difference between the air pressure measured by the sensor 280 for the electronic device 201 and the air pressure provided from the external device for the external device. Additionally or alternatively, the processor 220 may control the display 260 to display information of the direction in which the external device is located.

According to one exemplary embodiment, the processor 220 may set a period for detecting the direction of the external device based on the movement of the electronic device 201. For example, the processor 220 may detect a movement means of the electronic device 201 based on at least one of a frame duration time measured via the acceleration sensor, an air pressure change rate, and whether air pressure is uniformly changed. The processor 220 may set the period of detecting the direction of the external device to correspond to the movement means of the electronic device 201. Specifically, the processor 220 may set the period of detecting the direction of the external device to correspond to a movement speed of the electronic device 201 depending on the movement means of the electronic device 201. For example, the processor 220 may set the period of detecting the direction of the external device such that the faster the movement speed of the electronic device 201, the shorter the period. For example, the movement means of the electronic device 201 may include at least one of an elevator, an escalator, and a stairway.

According to one exemplary embodiment, if the difference between the air pressure of the electronic device 201 and the air pressure of the external device is within a reference range (e.g., 0.9 hPa), the processor 220 may determine that the electronic device 201 is located in the same floor as the external device (e.g., the electronic device 202 or 204 or server 206). If it is determined that the electronic device 201 is located in the same floor as the external device (e.g., the electronic device 202 or 204), the processor 220 may control the display 260 to display arrival information.

According to one exemplary embodiment, if the external device (e.g., the electronic device 202 or 204) is a vehicle, the processor 220 may detect the vehicle for providing a location guidance service based on at least one of a near-distance communication connection with the external device (e.g., the electronic device 202 or 204 or server 206) and movement information of the electronic device 201. For example, the processor 220 may determine a type of movement of the electronic device 201 based on sensor data detected via at least one of an acceleration sensor and a gyro sensor. If it is determined that the electronic device 201 is in a state of being placed in the vehicle (e.g., the electronic device 202 or 204), the processor 220 may identify whether a communication module of the vehicle (e.g., the electronic device 202 or 204) is detected through near-distance communication (e.g., Bluetooth®). If the communication module of the vehicle (e.g., the electronic device 202 or 204) is accessed through near-distance communication or if the communication module of the vehicle is searched for, the processor 220 may determine that a location guidance service is to be provided for the vehicle in which the electronic device 201 is placed. For example, the processor 220 may determine whether the location guidance service can be provided for the vehicle (e.g., the electronic device 202 or 204) in which the electronic device 201 is placed based on the number of times for detecting (or the number of times of connecting) the communication module of the vehicle in which the electronic device 201 is placed through near-distance communication. For example, the processor 220 may determine whether the location guidance service can be provided for the vehicle (e.g., the electronic device 202 or 204) in which the electronic device 201 is placed by using vehicle identification information provided from a control device of the vehicle (e.g., the electronic device 202 or 204).

According to one exemplary embodiment, if the external device (e.g., the electronic device 202 or 204) is a vehicle, the processor 220 may detect a parking state of the vehicle based on at least one of a near-distance communication connection with the external device and movement information of the electronic device 201. For example, the processor 220 may identify whether the electronic device 201 is placed in the vehicle (e.g., the electronic device 202 or 204) based on at least one of the near-distance communication connection with the external device and the movement information of the electronic device 201. For example, if the near-distance communication connection with the vehicle (e.g., the electronic device 202 or 204) is released or if the communication module of the vehicle is not searched for through the near-distance communication, the processor 220 may determine that the vehicle is parked. For example, if the movement state of the electronic device 201 is changed to walking or running, the processor 220 may determine that the vehicle (e.g., the electronic device 202 or 204) is parked.

The memory 230 may include a volatile and/or a non-volatile memory. The memory 230 may store an instruction or data related to at least one different constitutional element of, for example, the electronic device 201. According to one exemplary embodiment, the memory 230 may store a software and/or a program 240. For example, the program 240 may include a kernel 241, a middleware 243, an Application Programming Interface (API) 245, and/or an application program (or an “application”) 247, or the like. At least one part of the kernel 241, middleware 243, or API 245 may be referred to as an Operating System (OS).

The kernel 241 may control or manage, for example, system resources (e.g., the bus 210, the processor 220, the memory 230, etc.) used to execute an operation or function implemented in other programs (e.g., the middleware 243, the API 245, or the application program 247). Further, the kernel 241 may provide an interface capable of controlling or managing the system resources by accessing individual constitutional elements of the electronic device 201 in the middleware 243, the API 245, or the application program 247.

The middleware 243 may perform, for example, a mediation role so that the API 245 or the application program 247 can communicate with the kernel 241 to exchange data. Further, the middleware 243 may handle one or more task requests received from the application program 247 according to a priority. For example, the middleware 243 may assign a priority capable of using the system resources (e.g., the bus 210, the processor 220, or the memory 230) of the electronic device 201 to at least one of the application programs 247, and may handle the one or more task requests. The API 245 may include at least one interface or function (e.g., instruction), for example, for file control, window control, video processing, or character control, as an interface capable of controlling a function provided by the application 247 in the kernel 241 or the middleware 243.

The input/output interface 250 may play a role of, for example, an interface capable of delivering an instruction or data input from a user or a different external device(s) to the different constitutional elements of the electronic device 201.

The display 260 may include various types of displays, for example, a Liquid Crystal Display (LCD), a Light Emitting Diode (LED) display, an Organic Light-Emitting Diode (OLED) display, a MicroElectroMechanical Systems (MEMS) display, or an electronic paper display. The display 260 may display, for example, a variety of contents (e.g., text, image, video, icon, symbol, or the like) to the user. The display 260 may include a touch screen, and may receive a touch, gesture, proximity, or hovering input by using, for example, an electronic pen or a part of a user's body.

The communication interface 270 may establish communication, for example, between the electronic device 201 and the external device (e.g., a 1st electronic device 202, a 2nd electronic device 204, or a server 206). For example, the communication interface 270 may communicate with the external device (e.g., the 2nd electronic device 204 or the server 206) by being connected with a network 272 through wireless communication or wired communication.

The wireless communication may include, for example, cellular communication using at least one of LTE, LTE Advance (LTE-A), code division multiple access (CDMA), Wideband CDMA (WCDMA), Universal Mobile Telecommunications System (UMTS), Wireless Broadband (WiBro), Global System for Mobile Communications (GSM), etc. According to one exemplary embodiment, the wireless communication may include, for example, at least one of Wireless Fidelity (WiFi), Bluetooth, Bluetooth Low Energy (BLE), Zigbee, Near Field Communication (NFC), magnetic secure transmission, Radio Frequency (RF), Body Area Network (BAN), etc. According to one exemplary embodiment, the wireless communication may include a Global Navigation Satellite System (GNSS). The GNSS may be, for example, Global Positioning System (GPS), Global Navigation Satellite System (Glonass), Beidou Navigation Satellite System(hereinafter, “Beidou”) or Galileo, the European global satellite-based navigation system, etc. Hereinafter, the “GPS” and the “GNSS” may be used interchangeably in the present document. The wired communication may include, for example, at least one of Universal Serial Bus (USB), High Definition Multimedia Interface (HDMI), Recommended Standard-232 (RS-232), power-line communication, Plain Old Telephone Service (POTS), etc. The network 272 may include, for example, at least one of a telecommunications network, a computer network (e.g., LAN or WAN), the Internet, and a telephone network.

Each of the 1st and 2nd electronic devices 202 and 204 may be the same type or different type of the electronic device 201. According to various exemplary embodiments, all or some of operations executed by the electronic device 201 may be executed in a different one or a plurality of electronic devices (e.g., the electronic devices 202 or 204 or the server 206). According to one exemplary embodiment, if the electronic device 201 needs to perform a certain function or service either automatically or at a request, the electronic device 201 may request at least a part of functions related thereto alternatively or additionally to a different electronic device (e.g., the electronic device 202 or 204 or the server 206) instead of executing the function or the service autonomously. The different electronic device (e.g., the electronic device 202 or 204 or the server 206) may execute the requested function or additional function, and may deliver a result thereof to the electronic device 201. The electronic device 201 may provide the requested function or service either directly or by additionally processing the received result. For this, for example, a cloud computing, distributed computing, or client-server computing technique may be used.

The sensor 280 may measure physical quantity corresponding to the electronic device 201 or detect an operational status of the electronic device 201. For example, the sensor 280 may include at least one of a gesture sensor, a gyro sensor, an air pressure sensor, and an acceleration sensor. Additionally or alternatively, the sensor 280 may further include a control circuit for controlling at least one sensor.

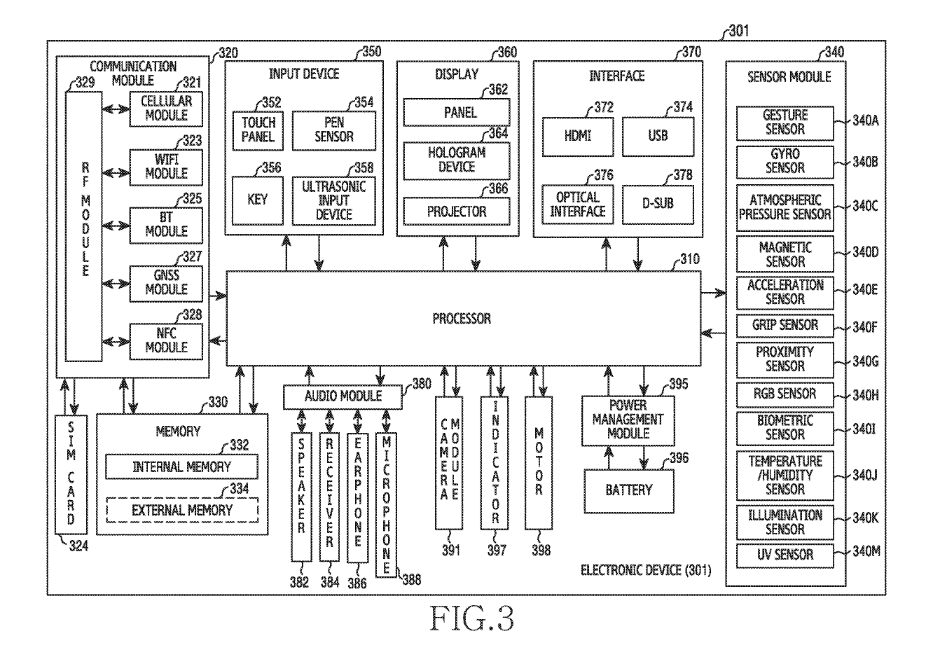

FIG. 3 is a block diagram of an electronic device 301 according to various exemplary embodiments. The electronic device 301 may include, for example, all or some parts of the electronic device 201 of FIG. 2.

Referring to FIG. 3, the electronic device 301 may include one or more processors (e.g., Application Processors (APs)) 310, a communication module 320, a subscriber identity module (e.g., SIM card) 324, a memory 330, a sensor module 340, an input device 350, a display 360, an interface 370, an audio module 380, a camera module 391, a power management module 395, a battery 396, an indicator 397, and a motor 398.

The processor 310 may control a plurality of hardware or software constitutional elements connected to the processor 310 by driving, for example, an operating system or an application program, and may process a variety of data including multimedia data and may perform an arithmetic operation. The processor 310 may be implemented, for example, with a System on Chip (SoC). According to one exemplary embodiment, the processor 310 may further include a Graphic Processing Unit (GPU) and/or an image signal processor. The processor 310 may include at least one part (e.g., a cellular module 321) of the constitutional elements of FIG. 3. The processor 310 may process an instruction or data, which is received from at least one of different constitutional elements (e.g., a non-volatile memory), by loading it to a volatile memory and may store a variety of data in the non-volatile memory.

The communication module 320 may have the same or similar structure as the communication interface 270 of FIG. 2. The communication module 320 may include, for example, the cellular module 321, a WiFi module 323, a BlueTooth® (BT) module 325, a Global Direction guide Satellite System (GNSS) module 327, a Near Field Communication (NFC) module 328, and a Radio Frequency (RF) module 329.

The cellular module 321 may provide, for example, a voice call, a video call, a text service, an Internet service, or the like through a communication network. According to one exemplary embodiment, the cellular module 321 may identify and authenticate the electronic device 301 in the communication network by using the subscriber identity module (e.g., a SIM card) 324. According to one exemplary embodiment, the cellular module 321 may perform at least some functions that can be provided by the processor 310. According to one exemplary embodiment, the cellular module 321 may include a Communication Processor (CP).

According to a certain exemplary embodiment, at least some (e.g., two or more) of the cellular module 321, the WiFi module 323, the BT module 325, the GNSS module 327, and the NFC module 328 may be included in one Integrated Chip (IC) or IC package.

The RF module 329 may transmit/receive, for example, a communication signal (e.g., a Radio Frequency (RF) signal). The RF module 329 may include, for example, a transceiver, a Power Amp Module (PAM), a frequency filter, a Low Noise Amplifier (LNA), an antenna, or the like. According to another exemplary embodiment, at least one of the cellular module 321, the WiFi module 323, the BT module 325, the GNSS module 327, and the NFC module 328 may transmit/receive an RF signal via a separate RF module. The subscriber identity module (e.g., a SIM card) 324 may include, for example, a card including the subscriber identity module and/or an embedded SIM, and may include unique identification information (e.g., an Integrated Circuit Card IDentifier (ICCID)) or subscriber information (e.g., an International Mobile Subscriber Identity (IMSI)).

The memory 330 (e.g., the memory 230 of FIG. 2) may include, for example, an internal memory 332 or an external memory 334. The internal memory 332 may include, for example, at least one of a volatile memory (e.g., a Dynamic RAM (DRAM), a Static RAM (SRAM), a Synchronous Dynamic RAM (SDRAM), etc.) and a non-volatile memory (e.g., a One Time Programmable ROM (OTPROM), a Programmable ROM (PROM), an Erasable and Programmable ROM (EPROM), an Electrically Erasable and Programmable ROM (EEPROM), a mask ROM, a flash ROM, a flash memory (e.g., a NAND flash memory, a NOR flash memory, etc.), a hard drive, or a Solid State Drive (SSD)). The external memory 334 may further include a flash drive, for example, Compact Flash (CF), Secure Digital (SD), Micro Secure Digital (Micro-SD), Mini Secure digital (Mini-SD), extreme Digital (xD), memory stick, or the like. The external memory 334 may be operatively and/or physically connected to the electronic device 301 via various interfaces.

The sensor module 340 (e.g., the sensor 280 of FIG. 2) may measure, for example, physical quantity or detect an operational status of the electronic device 301, and may convert the measured or detected information into an electric signal. The sensor module 340 may include, for example, at least one of a gesture sensor 340A, a gyro sensor 340B, an air pressure sensor 340C, a magnetic sensor 340D, an acceleration sensor 340E, a grip sensor 340F, a proximity sensor 340G, a color sensor 340H (e.g., a Red, Green, Blue (RGB) sensor), a bio sensor 3401, a temperature/humidity sensor 340J, an illumination sensor 340K, and an Ultra Violet (UV) sensor 340M. Additionally or alternatively, the sensor module 340 may include, additional sensors, not show, for example, an E-nose sensor, an ElectroMyoGraphy (EMG) sensor, an ElectroEncephaloGram (EEG) sensor, an ElectroCardioGram (ECG) sensor, an Infrared (IR) sensor, an iris sensor, and/or a fingerprint sensor. The sensor module 340 may further include a control circuit for controlling at least one or more sensors included therein. In a certain exemplary embodiment, the electronic device 301 may further include a processor configured to control the sensor module 304 either separately or as one part of the processor 310, and may control the sensor module 340 while the processor 310 is in a sleep state. For example, the temperature/humidity sensor 340J may include a plurality of temperature sensors disposed at different locations.

The input device 350 may include, for example, a touch panel 352, a (digital) pen sensor 354, a key 356, or an ultrasonic input device 358. The touch panel 352 may recognize a touch input, for example, by using at least one of an electrostatic type, an air pressure-sensitive type, and an ultrasonic type. In addition, the touch panel 352 may further include a control circuit. The touch panel 352 may further include a tactile layer and thus may provide the user with a tactile reaction. The (digital) pen sensor 354 may be, for example, one part of a touch panel, or may include an additional sheet for recognition. The key 356 may be, for example, a physical button, an optical key, a keypad, or a touch key. The ultrasonic input device 358 may detect an ultrasonic wave generated from an input means through a microphone (e.g., a microphone 388) to identify data corresponding to the detected ultrasonic wave.

The display 360 (e.g., the display 260 of FIG. 2) may include a panel 362, a hologram unit 364, a projector 366, and/or a control circuit for controlling these elements. The panel 362 may be implemented, for example, in a flexible, transparent, or wearable manner. The panel 362 may be constructed as one module with the touch panel 352. The hologram unit 364 may use an interference of light and show a stereoscopic image in the air. The projector 366 may display an image by projecting a light beam onto a screen. The screen may be located, for example, inside or outside the electronic device 301. The interface 370 may include, for example, a High-Definition Multimedia Interface (HDMI) 372, a Universal Serial Bus (USB) 374, an optical communication interface 376, or a D-subminiature (D-sub) 378. The interface 370 may be included, for example, in the communication interface 270 of FIG. 2. Additionally or alternatively, the interface 370 may include, for example, a Mobile High-definition Link (MHL) interface, a Secure Digital (SD)/Multi-Media Card (MMC) interface, or an Infrared Data Association (IrDA) standard interface.

The audio module 380 may bilaterally convert, for example, a sound and electric signal. At least some constitutional elements of the audio module 380 may be included in, for example, the input/output interface 250 of FIG. 2. The audio module 380 may convert sound information which is input or output, for example, through a speaker 382, a receiver 384, an earphone 386, the microphone 388, or the like.

The camera module 391 is, for example, a device for image and video capturing, and according to one exemplary embodiment, may include one or more image sensors (e.g., a front sensor or a rear sensor), a lens, an Image Signal Processor (ISP), or a flash (e.g., LED or xenon lamp). The power management module 395 may manage, for example, power of the electronic device 301.

The power management module 395 may include a Power Management Integrated Circuit (PMIC), a charger Integrated Circuit (IC), or a battery fuel gauge. The PMIC may have a wired and/or wireless charging type. The wireless charging type may include, for example, a magnetic resonance type, a magnetic induction type, an electromagnetic type, or the like, and may further include an additional circuit for wireless charging, for example, a coil loop, a resonant circuit, a rectifier, or the like. The battery gauge may measure, for example, residual quantity of the battery 396 and voltage, current, and temperature during charging. The battery 396 may include, for example, a rechargeable battery and/or a solar battery.

The indicator 397 may indicate a specific state, for example, a booting state, a message state, a charging state, or the like, of the electronic device 301 or one part thereof (e.g., the processor 310). The motor 398 may convert an electric signal into a mechanical vibration, and may generate a vibration or haptic effect. The electronic device 301 may include a mobile TV supporting device (e.g., a GPU) capable of handling media data according to a protocol of, for example, Digital Multimedia Broadcasting (DMB), Digital Video Broadcasting (DVB), media flow, or the like.

Each of the constitutional elements described in the present document may consist of one or more components, and names thereof may vary depending on a type of the electronic device. According to various exemplary embodiments, some of the constitutional elements of the electronic device (e.g., the electronic device 301) may be omitted, or additional other constitutional elements may be further included. Further, some of the constitutional elements of the electronic device may be combined and constructed as one entity while performing the same functions of corresponding constitutional elements as before they are combined.

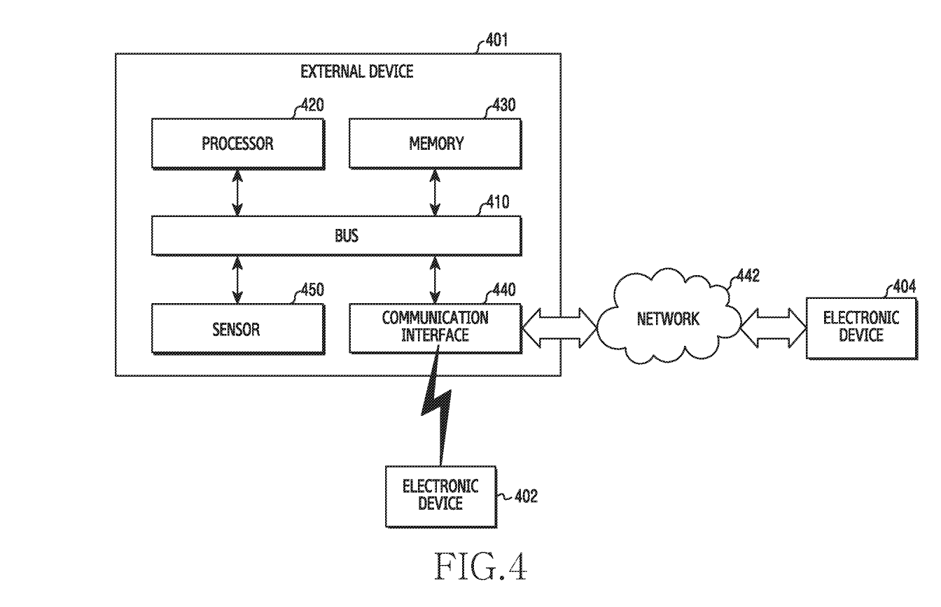

FIG. 4 is a block diagram of an external device according to various exemplary embodiments of the present invention. In the following description, an external device 401 may include all or some parts of the external device 110, 120, or 130 of FIG. 1. Additionally or alternatively, external device 401 may include all or some parts of the electronic device 201 of FIG. 2, and electronic device 301 of FIG. 3.

Referring to FIG. 4, the external device 401 may include a bus 410, a processor 420 (e.g., including processing circuitry), a memory 430, a communication interface 440 (e.g., including communication circuitry), and a sensor 450. In a certain exemplary embodiment, the external device 401 may omit at least one of the constitutional elements or may additionally include other constitutional elements.

The bus 410 may include a circuit for connecting, for example, the constitutional elements 420 to 450 to each other and for delivering communication (e.g., a control message and/or data) between the aforementioned constitutional elements.

The processor 420 may include one or more of a Central Processing Unit (CPU), an Application Processor (AP), and a Communication Processor (CP). For example, the processor 420 may execute an arithmetic operation or data processing for control and/or communication of different constitutional elements of the external device 401.

According to one exemplary embodiment, the processor 420 may provide control to transmit air pressure information of the external device 401 to the electronic device 402 or 404. For example, upon reception of an air pressure request signal via the communication interface 440, the processor 420 may control the communication interface 440 such that air pressure information measured via the sensor 450 for the external device 401 is transmitted to the electronic device 402 or 404.

According to one exemplary embodiment, the processor 420 may provide control to selectively transmit the air pressure information of the external device 401 based on whether the electronic device 402 or 404 which has transmitted the air pressure request signal is authenticated. For example, if the electronic device 402 or 404 is included in a location sharing list (or a membership management list) stored in the memory 430, the processor 420 may determine that the electronic device 402 or 404 is authenticated. If the electronic device 402 or 404 is authenticated, the processor 420 may control the communication interface 440 to transmit the air pressure information of the external device 401 to the electronic device 402 or 404. For example, if the air pressure request signal received from the electronic device 402 or 404 includes disaster information, the processor 420 may skip the authentication procedure of the electronic device 402 or 404.

According to one exemplary embodiment, if the air pressure information of the external device 401 is transmitted to estimate the location of the external device 401, the processor 420 may provide control such that the air pressure information of the external device 401 is periodically transmitted to the electronic device 402 or 404. For example, the processor 420 may determine an air pressure information update period based on weather of a region in which the external device 401 is located. For example, if an air pressure change is relatively small due to fine weather, the processor 420 may determine a first reference time (e.g., 5 minutes) as the air pressure information update period. For example, if the air pressure change is relatively severe due to rainy or cloudy weather, the processor 420 may determine a second reference time (e.g., 30 seconds to 1 minute) as the air pressure update period. For example, the processor 420 may control the communication interface 440 to periodically transmit the air pressure information of the external device 401 to the electronic device 402 or 404 until a location estimation service of the external device 401 is terminated by the electronic device 402 or 404.

According to one exemplary embodiment, if the external device 401 is a vehicle control device, the processor 420 may provide control such that air pressure information measured via the sensor 450 for the external device 401 at a parking time of the vehicle is transmitted to the electronic device 402 or 404. For example, if the communication connection with the electronic device 402 through near-distance communication is released, the processor 420 may determine that the vehicle is parked. If it is determined that the vehicle is parked, the processor 420 may control the communication interface 440 such that the air pressure information measured via the sensor 450 for the external device 401 is transmitted to the electronic device 402 or 404.

The memory 430 may include a volatile and/or a non-volatile memory. The memory 430 may store an instruction or data related to at least one different constitutional element of, for example, the external device 401.

The communication interface 440 may establish a communication, for example, between the external device 401 and the electronic device (e.g., the 1st electronic device 402 or the 2nd electronic device 404). For example, the communication interface 440 may communicate with the 2nd electronic device 404 by being connected with a network 442 through a wireless communication or a wired communication.

The wireless communication may include, for example, cellular communication using at least one of LTE, LTE-A, CDMA, WCDMA, UMTS, WiBro, GSM, etc. According to one exemplary embodiment, the wireless communication may include, for example, at least one of WiFi, Bluetooth, BLE, Zigbee, NFC, magnetic secure transmission, RF, BAN, etc. According to one exemplary embodiment, the wireless communication may include a GNSS. The wired communication may include, for example, at least one of USB, HDMI, RS-232, power-line communication, POTS, etc. The network 442 may include, for example, at least one of a telecommunications network, a computer network (e.g., LAN or WAN), the Internet, and a telephone network.

The sensor 450 may measure physical quantity corresponding to the external device 401 or detect an operational status of the external device 401. For example, the sensor 450 may include at least one of a gesture sensor, a gyro sensor, an air pressure sensor, and an acceleration sensor. Additionally or alternatively, the sensor 450 may further include a control circuit for controlling at least one sensor.

According to various exemplary embodiments of the present invention, an electronic device includes an air pressure sensor, a display, and a processor. The processor may be configured for identifying air pressure of an external device, detecting air pressure of a region in which the electronic device is located by using the air pressure sensor, detecting a direction in which the external device is located based on a difference between the air pressure of the external device and the air pressure of the region in which the electronic device is located, and controlling the display to display the direction in which the external device is located.

According to various exemplary embodiments, the electronic device further includes a memory for storing air pressure information of the external device. The processor may be configured for determining whether to use the air pressure information based on a valid time, stored in the memory, for the external device, and if it is determined that the air pressure information can be used, detecting the direction in which the external device is located based on a difference between the air pressure, stored in the memory, for the external device and the air pressure of the region in which the electronic device is located.

According to various exemplary embodiments, the valid time of the air pressure information may be dynamically configured based on a weather of the region in which the electronic device is located.

According to various exemplary embodiments, the electronic device further includes a communication interface. The processor may be configured for transmitting an air pressure request signal to the external device through the communication interface if it is determined that a usage of the air pressure information is limited, receiving air pressure information of the external device from the external device through the communication interface in response to the air pressure request signal, and detecting the direction in which the external device is located based on a difference between air pressure received from the external device for the external device and the air pressure of the region in which the electronic device is located.

According to various exemplary embodiments, the processor may be configured for determining that, if the air pressure of the external device is lower than the air pressure of the region in which the electronic device is located, the external device is located in an upward direction with respect to the location of the electronic device, and if the air pressure of the external device is higher than the air pressure of the region in which the electronic device is located, the external device is located in a downward direction with respect to the location of the electronic device.

According to various exemplary embodiments, the processor may be configured for determining that, if the difference between the air pressure of the external device and the air pressure of the region in which the electronic device is located is within a reference range, the external device and the electronic device are located in the same floor.

According to various exemplary embodiments, the processor may be configured for, upon detection of a movement of the electronic device, determining a period of detecting a direction of the external device based on a movement speed of the electronic device, upon arrival of the period of detecting the direction of the external device, detecting the air pressure of the region in which the electronic device is located by using the air pressure sensor, detecting the direction in which the external device is located based on the difference between the air pressure of the external device and the air pressure of the region in which the electronic device is located, and updating direction information, displayed on the display, for the direction in which the external device is located based on the direction in which the external device is located.

According to various exemplary embodiments, the processor may be configured for, upon reception of the air pressure information from the external device, detecting the direction in which the external device is located based on the difference between the air pressure received from the external device and the air pressure of the region in which the electronic device is located, and updating direction information, displayed on the display, for the direction in which the external device is located based on the direction in which the external device is located.

According to various exemplary embodiments, the processor may be configured for setting an update period for air pressure information of the external device based on weather of the region in which the electronic device is located, upon arrival of the update period, transmitting an air pressure request signal to the external device, and receiving air pressure information from the external device in response to the air pressure request signal.

According to various exemplary embodiments, the external device may include at least one of a vehicle control device and another electronic device.

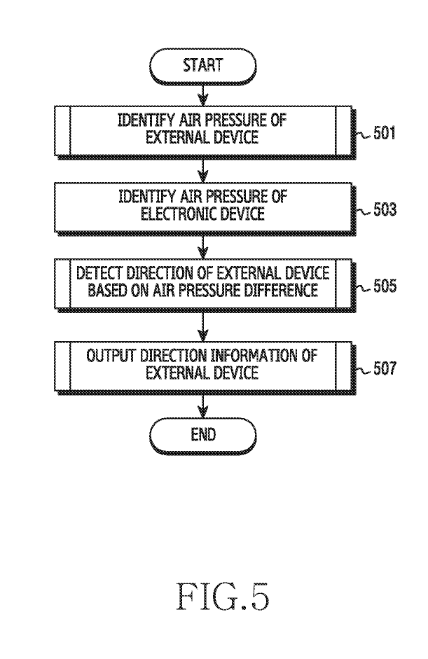

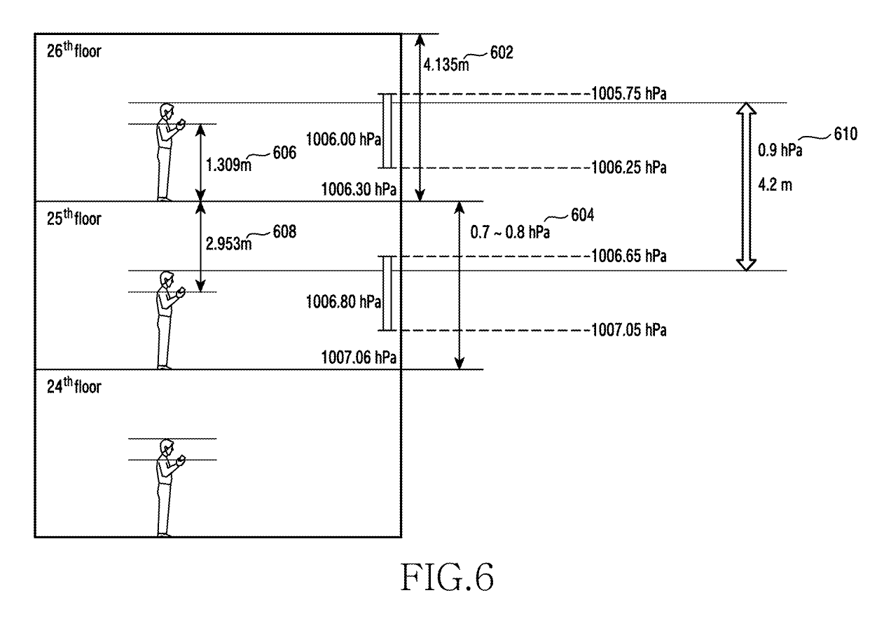

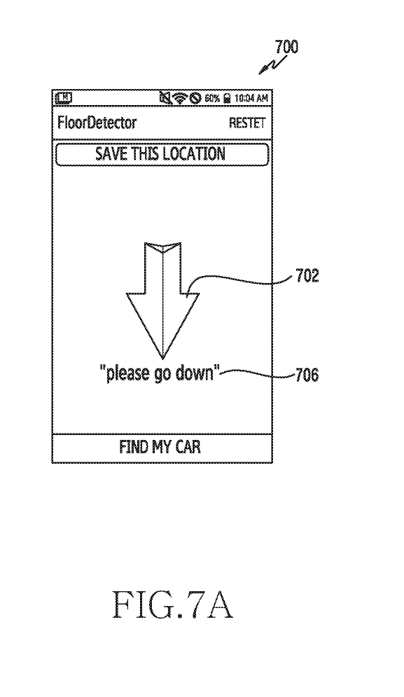

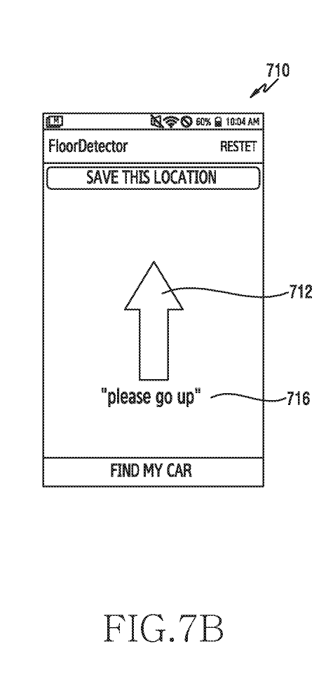

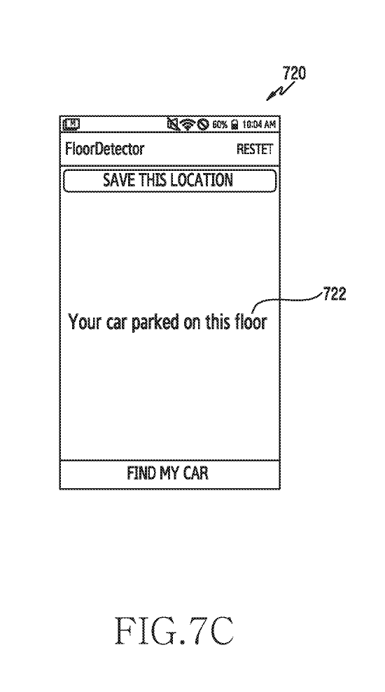

FIG. 5 illustrates a flowchart for detecting a direction of an external device by using air pressure information by an electronic device according to various exemplary embodiments of the present invention. FIG. 6 illustrates a configuration for identifying a floor of a building by using air pressure information by an electronic device according to various exemplary embodiments of the present invention. FIG. 7A to FIG. 7C illustrate a screen configuration for displaying a direction of an external device by an electronic device according to various exemplary embodiments of the present invention. In the following description, the electronic device may include all or some parts (e.g., the processor 220) of the electronic device 201 of FIG. 2.

Referring to FIG. 5, in operation 501, the electronic device may determine air pressure of an external device for estimating location information. For example, if the memory 230 has reliable air pressure information stored therein for the external device, the processor 220 may identify the air pressure information, stored in the memory 230, for the external device. For example, the processor 220 may control the communication interface 270 to transmit the air pressure request signal to the external device in response to the occurrence of the location guidance event. The processor 220 may receive the air pressure information of the external device from the external device in response to the air pressure request signal.

In operation 503, the electronic device may identify air pressure of a region in which the electronic device is located. For example, the processor 220 may identify the air pressure measured via the sensor 280 (e.g., the air pressure sensor) for the region (e.g., a floor) in which the electronic device 201 is located.

In operation 505, the electronic device may detect a direction (e.g., an upward/downward direction) in which the external device is located from the location of the electronic device based on the difference between the air pressure of the external device and the air pressure of the electronic device. For example, if the difference between the air pressure of the external device and the air pressure of the electronic device exceeds the reference range and if the air pressure of the electronic device 201 is lower than the air pressure of the external device, the processor 220 may determine that the external device is located in a lower floor than the electronic device 201. If the difference between the air pressure of the external device and the air pressure of the electronic device exceeds the reference range and if the air pressure of the electronic device 201 is higher than the air pressure of the external device, the processor 220 may determine that the external device is located in a higher floor than the electronic device 201. If the difference between the air pressure of the external device and the air pressure of the electronic device is within the reference range, the processor 220 may determine that the external device and the electronic device are located in the same floor. For example, as shown in FIG. 6, the processor 220 may estimate a height of the electronic device 201 grabbed by a user to determine a reference range 610 (e.g., 0.9 hPa) of air pressure for determining that the external device and the electronic device 201 are located in the same floor. Specifically, a height 602 of one floor may be limited to 4.135 m, and it may be assumed that an air pressure change of one floor is 0.7˜0.8 hPa. In case of being grabbed by the user, it may be estimated that the electronic device 201 is located at a first height 606 (e.g., 1.309 m) from a bottom of a corresponding floor (e.g., 26th floor) and is located at a second height 608 (e.g., 2.953 m) from a ceiling. Accordingly, the processor 220 may estimate that the electronic device 201 grabbed by the user has a height of 4.2 m. The processor 220 may set the reference range of the air pressure to 0.9 hPa based on the height of the electronic device 201 grabbed by the user, a height of one floor, and an air pressure change.

In operation 507, the electronic device may output information of the direction in which the external device is located from the location of the electronic device. For example, if it is determined that the external device is located on the lower floor than the electronic device 201, as shown in FIG. 7A, the processor 220 may control the display 260 to display a location guidance screen 700 indicating a downward direction. For example, the location guidance screen 700 may include an icon 702 indicating a downward direction and a guidance message 704 guiding to be directed downward. For example, if it is determined that the external device is located in the higher floor than the electronic device 201, as shown in FIG. 7B, the processor 220 may control the display 260 to display a location guidance screen 710 indicating an upward direction. For example, the location guidance screen 710 may include an icon 712 indicating an upward direction and a guidance message 714 guiding to be directed upward. For example, if it is determined that the external device is located in the same floor as the electronic device, as shown in FIG. 7C, the processor 220 may control the display 260 to display an arrival guidance screen 720. For example, the arrival guidance screen 720 may include a guidance message 722 indicating that the external device has arrived the floor in which the external device is located. Additionally or alternatively, the processor 220 may further display at least one of a movement speed and movement distance of the electronic device 201 to at least one area of the location guidance screen 700 or 710.

According to one exemplary embodiment, the electronic device may output the information of the direction in which the external device is located in a form of vibration, sound, or the like.

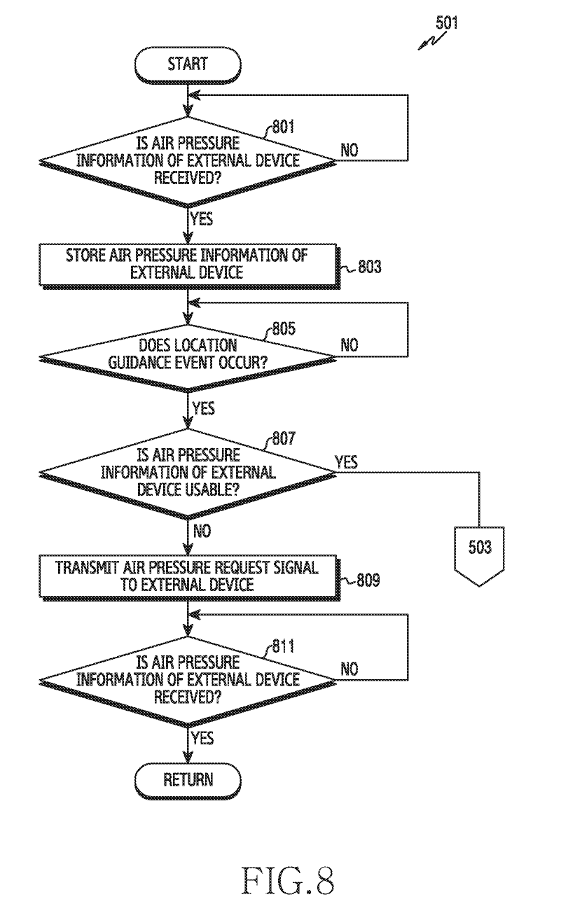

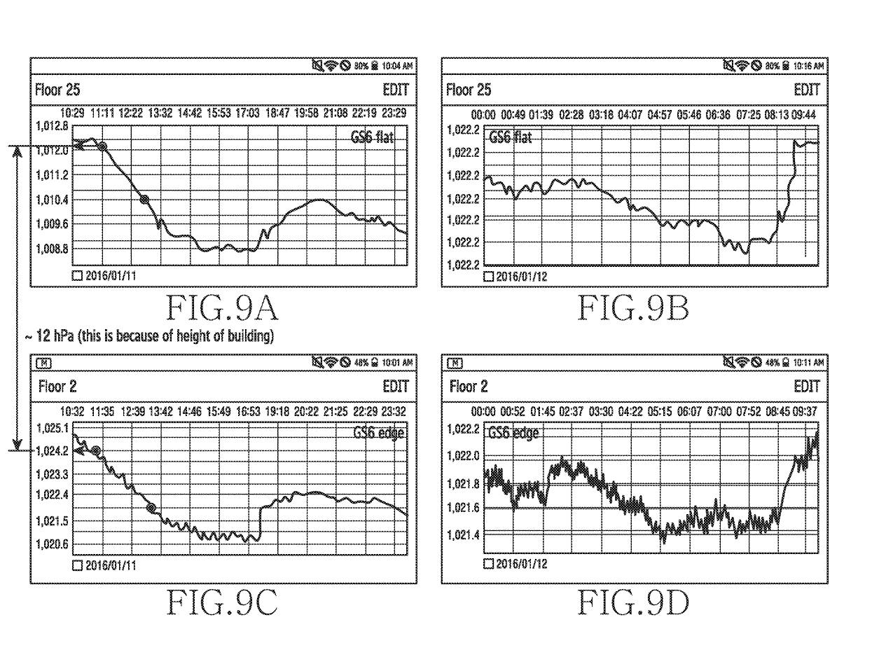

FIG. 8 illustrates a flowchart for identifying air pressure information of an external device by an electronic device according to various exemplary embodiments of the present invention. FIGS. 9A through 9D illustrate air pressure graphs according to various exemplary embodiments of the present invention. In the following description of FIG. 8, an operation for identifying air pressure of an external device by providing additional exemplary details to operation 501 of FIG. 5. In the following description, the electronic device may include all or some parts (e.g., the processor 220) of the electronic device 201 of FIG. 2.

Referring to FIG. 8, in operation 801, the electronic device may identify whether the air pressure information of the external device is received from the external device. For example, the processor 220 may identify whether air pressure information of a region in which a vehicle is located is received from a vehicle control device (the external device) placed in the vehicle in response to parking of the vehicle.

In operation 803, upon reception of the air pressure information of the external device from the external device, the electronic device may store the air pressure information of the external device in a memory of the electronic device. For example, upon reception of the air pressure information detected for the external device at a time of parking the vehicle via the communication interface 270, the processor 220 may store the air pressure information of the external device in the memory 230.

In operation 805, the electronic device may identify whether an event for a location guidance occurs. For example, the processor 220 may identify whether a user input is detected corresponding to the event for the location guidance via the input/output interface 250. For example, the user input corresponding to the event for the location guidance may include at least one of a selection input of a location guidance icon and a gesture input corresponding to the event for the location guidance.

In operation 807, upon detection of the occurrence of the event for the location guidance, the electronic device may identify whether the air pressure information, stored in the memory, for the external device can be used. For example, as shown in FIG. 9, the air pressure may vary continuously over time. Specifically, if the electronic device 201 is located in a 25th floor, air pressure measured at a first time as shown in FIG. 9A may be different from air pressure measured at a second time as shown in FIG. 9B. In addition, if the electronic device 201 is located in a 2nd floor, air pressure measured at a first time as shown in FIG. 9C may be different from air pressure measured at a second time as shown in FIG. 9D. Accordingly, the processor 220 may identify whether reliability on the air pressure information of the external device is valid based on a valid time of the air pressure information, stored in the memory 230, for the external device. For example, the valid time of the air pressure information may be set to correspond to weather of the electronic device 201 or a region in which the external device is located. Specifically, if an air pressure change is relatively small due to fine weather, the processor 220 may set the valid time of the air pressure information to be relatively long. If the air pressure change is relatively severe due to cloudy weather, the processor 220 may set the valid time of the air pressure information to be relatively short.

If it is determined the air pressure information, stored in the memory, for the external device can be used, in operation 503 of FIG. 5, the electronic device may identify air pressure of a region in which the electronic device is located.

If it is determined in operation 807 that the air pressure information, stored in the memory, for the external device cannot be used, in operation 809 the electronic device may transmit an air pressure request signal to the external device. For example, the air pressure request signal may include at least one of identification information and disaster information of the electronic device.

In operation 811, the electronic device may identify whether the air pressure information of the external device is received from the external device in response to the air pressure request signal.

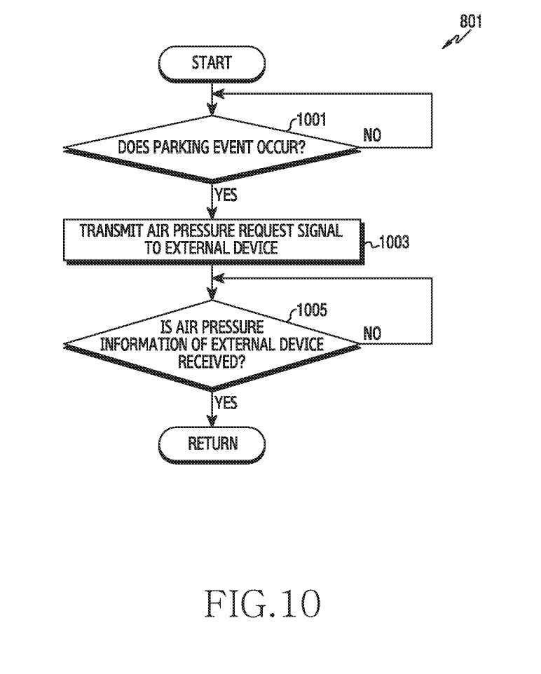

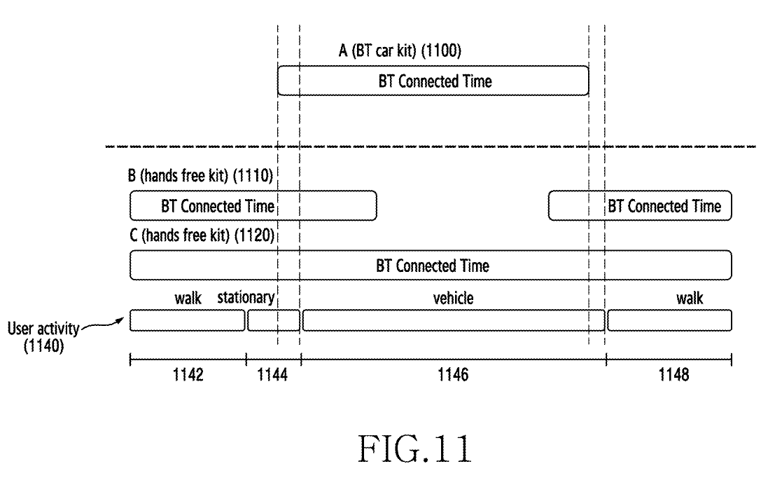

FIG. 10 illustrates a flowchart for acquiring air pressure information of a parked vehicle by an electronic device according to various exemplary embodiments of the present invention. FIG. 11 illustrates a configuration for determining whether being placed in a vehicle by an electronic device according to various exemplary embodiments of the present invention. In the following description of FIG. 10, an operation for identifying whether air pressure information of an external device is received by providing additional exemplary details to operation 801 of FIG. 8. In the following description, the electronic device may include the electronic device 100 of FIG. 1, and the external device may include the vehicle 110 of FIG. 1 or a vehicle control device for controlling the vehicle 110.

Referring to FIG. 10, in operation 1001, the electronic device may identify whether a parking event occurs. For example, as shown in FIG. 11, the processor 220 may determine an activity type 1140 (user activity) for a user of the electronic device 201 based on sensor data detected through at least one of an acceleration sensor and a gyro sensor. For example, an activity of the user may include at least one of walking states 1142 or 1148, stationary state 1144, and vehicle boarding state 1146. As shown in FIG. 11, if the user accesses a communication module of the vehicle through near-distance communication in a stationary state 1144 of being in proximity to the vehicle or a vehicle boarding state 1146 of boarding the vehicle or if the communication module of the vehicle is searched for, the processor 220 may determine that the vehicle is a vehicle capable of providing a location guidance service (see 1100). The processor 220 may detect a parking state of the vehicle based on at least one of a near-distance communication state with respect to the vehicle capable of providing the location guidance service and activity information of the user. For example, the near-distance communication state may include information regarding at least one of whether it has access to the communication module of the vehicle through the near-distance communication and whether the communication module of the vehicle is searched for.

In operation 1003, upon detection of the occurrence of the parking event, the electronic device may transmit the air pressure request signal to the external device. For example, the processor 220 may control the communication interface 270 such that the air pressure request signal is transmitted to the vehicle control device equipped in the vehicle corresponding to the parking event.

In operation 1005, the electronic device may identify whether the air pressure information of the external device is received from the external device in response to the air pressure request signal.

According to one exemplary embodiment, as shown in FIG. 11, if the user of the electronic device accesses the communication module of the vehicle through near-distance communication in the walking states 1142 and 1128 or if the communication module of the vehicle is searched for, the electronic device may recognize that the user does not board the vehicle for providing the location guidance service (see 1110).

According to one exemplary embodiment, as shown in FIG. 11, in case of persistently accessing the communication module of the vehicle through near-distance communication irrespective of the activity state of the user of the electronic device, it may be recognized that the user does not board the vehicle for providing the location guidance service (see 1120).

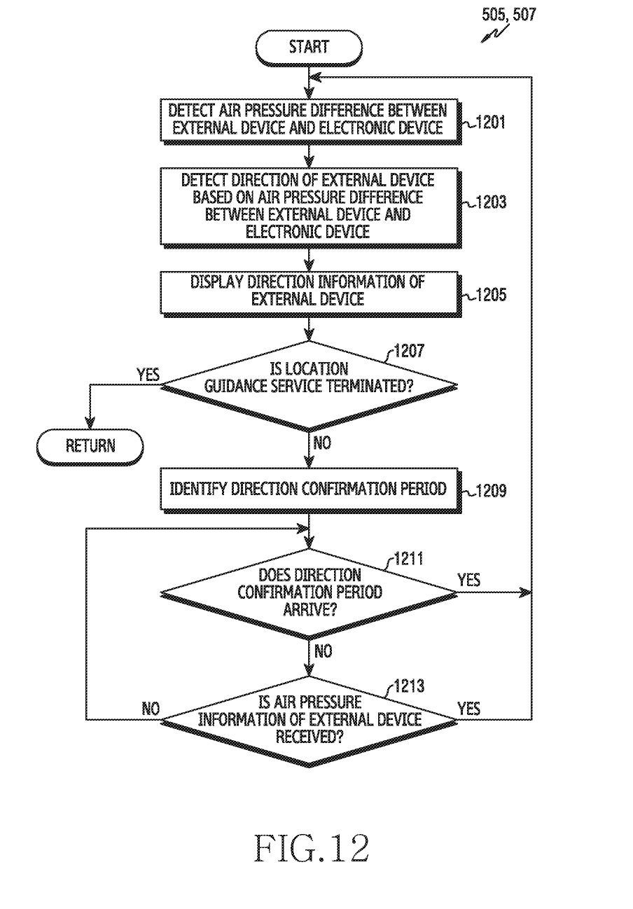

FIG. 12 illustrates a flowchart for periodically detecting a direction of an external device by an electronic device according to various exemplary embodiments of the present invention. In the following description of FIG. 12, an operation for detecting and outputting direction information of an external device by providing additional exemplary details to operation 505 and operation 507 of FIG. 5. In the following description, the electronic device may include all or some parts (e.g., the processor 220) of the electronic device 201 of FIG. 2.

Referring to FIG. 12, in operation 1201, the electronic device may detect an air pressure difference between the external device and the electronic device. For example, the processor 220 may detect a difference between air pressure acquired via the sensor 280 for a region in which the electronic device 201 is located and air pressure provided from the external device. For example, if it is determined that corresponding air pressure information is reliable based on a valid time of air pressure provided from the external device, the processor 220 may calculate a difference between air pressure provided from the external device and air pressure acquired via the sensor 280 for the electronic device 201.

In operation 1203, the electronic device may detect a direction in which the external device is located according to a location of the electronic device based on the air pressure difference between the external device and the electronic device. For example, the direction in which the external device is located may include an upward direction and downward direction with respect to the location of the electronic device 201 or information of the same floor as the external device.

In operation 1205, the electronic device may display information of the direction, in which the external device is located, on a display according to the location of the electronic device. For example, as shown in FIG. 7A or FIG. 7B, the processor 220 may control the display 260 to display the location guidance screen 700 or 710 including the information of the direction in which the external device is located according to the location of the electronic device. For example, if the electronic device and the external device are located in the same floor, as shown in FIG. 7C, the processor 220 may control the display 260 to display the arrival guidance screen 720.

In operation 1207, if the information of the direction in which the external device is located is displayed, the electronic device may identify whether the location guidance service is terminated. For example, if the electronic device and the external device are located in the same floor, the processor 220 may determine that the location guidance service for providing direction information of the external device is terminated. For example, the processor 220 may identify whether a user input corresponding to a type of the location guidance service is detected via the input/output interface 250.

In operation 1209, if the location guidance service is not terminated, the electronic device may identify a period for identifying the direction in which the external device is located. For example, the processor 220 may detect a movement speed of the electronic device 201 by using sensor data acquired via the sensor 280. The processor 220 may set a period for identifying the direction in which the external device is located based on the movement speed of the electronic device 201. For example, the processor 220 may set the period for identifying the direction in which the external device is located such that the faster the movement speed of the electronic device 201, the shorter the period. Additionally or alternatively, the processor 220 may estimate a movement means of the electronic device 201 by using the sensor data acquired via the sensor 280. The processor 220 may set the period for identifying the direction in which the external device is located to correspond to an estimated movement speed of the movement means of the electronic device 201.

In operation 1211, the electronic device may identify whether the period for identifying the direction in which the external device is located has arrived. For example, the processor 220 may identify whether a time corresponding to the period for identifying the direction in which the external device is located has elapsed from a time of identifying the direction in which the external device is located in operation 1203.

If the period for identifying the direction in which the external device is located has arrived, in operation 1201, the electronic device may detect again the air pressure difference between the external device and the electronic device. For example, the processor 220 may detect the air pressure difference between the external device and the electronic device 201 based onair pressure information newly detected for the electronic device 201 via the air pressure sensor included in the sensor 280.

In operation 1213, if the period for identifying the direction in which the external device is located has not arrived, the electronic device may identify whether the air pressure information is received from the external device. For example, if the location information of the external device is estimated by the electronic device 201, the external device may periodically transmit the air pressure information of the external device to the electronic device 201 so that reliability on the air pressure information of the external device is maintained. Accordingly, the processor 220 may identify whether the air pressure information of the external device is received from the external device in a state where the location information of the external device is displayed.

If the air pressure information of the external device is received from the external device, in operation 1201, the electronic device may detect again the air pressure information received from the external device and the air pressure difference of the electronic device. For example, the air pressure of the electronic device may include air pressure newly detected at a time of receiving the air pressure information from the external device.

If the air pressure information of the external device is not received from the external device, in operation 1211, the electronic device may identify again whether the period for identifying the direction in which the external device is located has arrived.

According to one exemplary embodiment, if the location guidance service is terminated, the electronic device may transmit a termination signal corresponding to the location guidance service to the external device.

According to one exemplary embodiment, if the location guidance service for the external device is provided, the electronic device may periodically transmit the air pressure request signal to the external device to maintain reliability on the air pressure information of the external device.

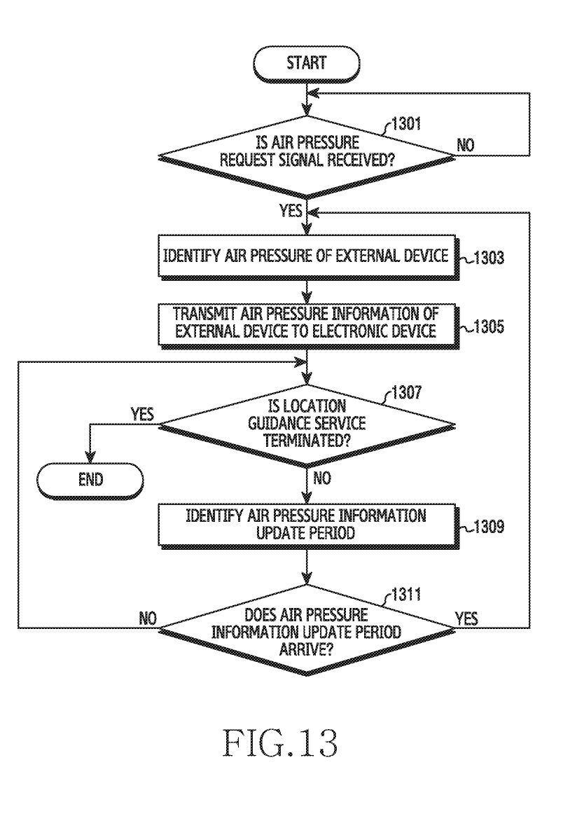

FIG. 13 illustrates a flowchart for transmitting air pressure information by an external device according to various exemplary embodiments of the present invention. In the following description, the external device may include all or some parts (e.g., the processor 420) of the external device 401 of FIG. 4.

Referring to FIG. 13, in operation 1301, the external device may identify whether an air pressure request signal is received from the electronic device. For example, the processor 420 may identify whether the air pressure request signal is received from the electronic device 402 or 404 via the communication interface 440.

In operation 1303, upon reception of the air pressure request signal, the external device may identify air pressure of a region in which the external device is located. For example, the processor 420 may determine whether the electronic device 402 or 404 which has transmitted the air pressure request signal can be authenticated. For example, the processor 420 may identify whether the electronic device 402 or 404 is included in a pre-defined location sharing list based on identification information included in the air pressure request signal for the electronic device 402 or 404. If the identification information of the electronic device 402 or 404 is included in the location sharing list, the processor 420 may determine that the electronic device 402 or 404 is successfully authenticated. If the electronic device 402 or 404 which has transmitted the air pressure request signal is authenticated, the processor 420 may measure air pressure of a region in which the external device 401 is located by using the sensor 450 (e.g., an air pressure sensor). For example, if disaster information is included in the air pressure request signal, the processor 420 may skip the authentication procedure of the electronic device 402 or 404. That is, the processor 420 may measure the air pressure of the region in which the external device 401 is located by using the sensor 450 (e.g., the air pressure sensor) in response to reception of the air pressure request signal.

In operation 1305, the external device may transmit air pressure information of the external device to the electronic device which has transmitted the air pressure request signal in response to the air pressure request signal.

In operation 1307, the external device may identify whether a location guidance service for estimating a location of the external device by the electronic device is terminated. For example, the processor 420 may identify whether a termination signal corresponding to the location guidance service is received from the electronic device via the communication interface 440. For example, if near-distance communication is connected with the electronic device via the communication interface 440, the processor 420 may determine that the location guidance service based on the electronic device is terminated.

In operation 1309, if the location guidance service based on the electronic device is not terminated, the external device may identify an update period of air pressure information corresponding to the location guidance service based on the electronic device. For example, the processor 420 may adjust the air pressure information update period corresponding to weather of the region in which the external device 401 is located. Specifically, the processor 420 may set the update period of the air pressure information based on the weather of the region in which the external device is located such that the smaller the air pressure change, the longer the update period.

In operation 1311, the external device may identify whether the update period of the air pressure information has arrived. For example, the processor 420 may identify whether a time corresponding to the update period of the air pressure information of the external device elapses from a time of transmitting the air pressure information of the external device to the electronic device in operation 1305.

If the update period of the air pressure information has arrived, in operation 1303, the external device may identify again the air pressure of the region in which the external device is located.

If the update period of the air pressure information has not arrived, in operation 1307, the external device may identify again whether the location guidance service for estimating the location of the external device is terminated by the electronic device.

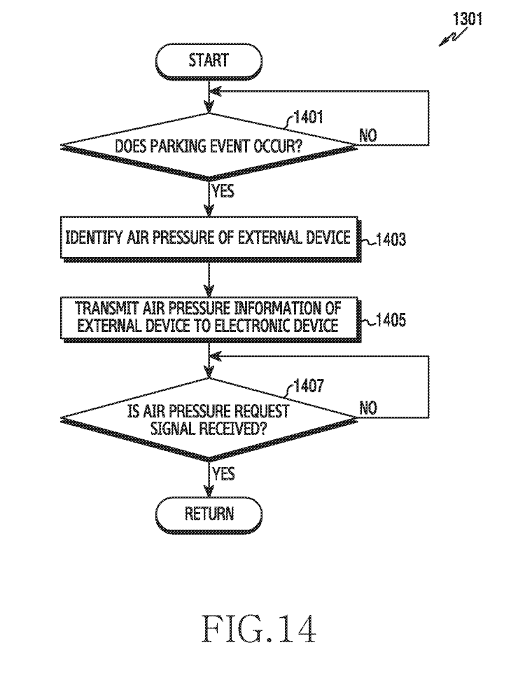

FIG. 14 illustrates a flowchart for transmitting air pressure information of a parking location by an external device according to various exemplary embodiments of the present invention. In the following description of FIG. 14, an operation for receiving an air pressure request signal by providing additional exemplary details to operation 1301 of FIG. 13. In the following description, the external device may include the vehicle 110 of FIG. 1 or the vehicle control device for controlling the vehicle 110.

Referring to FIG. 14, in operation 1401, the external device may identify whether a parking event occurs. For example, the processor 420 may establish a communication link with respect to the neighboring electronic device 402 through near-distance communication (e.g., Bluetooth). For example, in case of the vehicle control device of the external device 401, the processor 420 may connect communication with the electronic device 402 which is placed in a vehicle in a near-distance communication manner. If the communication connection with the electronic device 402 is released, the processor 420 may determine that a parking event has occurred. For example, the processor 420 may identify whether the parking event occurs based on state information of the vehicle. For example, if engine driving of the vehicle is terminated, the processor 420 may determine that the parking event has occurred.

In operation 1403, if the parking event has occurred, the external device may identify air pressure of the region in which the external device (e.g., the vehicle) is located. For example, the processor 420 may measure the air pressure of the region in which the external device 401 is located by using the sensor 450 (e.g., the air pressure sensor) electrically connected with the external device 401.

In operation 1405, the external device may transmit the air pressure of the region in which the external device is located (e.g., a location in which the vehicle is parked) to the electronic device. For example, the processor 420 may transmit air pressure information measured at a time of parking the external device 401 to the electronic device 404 by using cellular communication supported in the communication interface 440.

In operation 1407, the external device may identify whether the air pressure request signal is received from the electronic device. For example, the processor 420 may transition to a low-power standby mode after transmitting the air pressure information of the external device 401 in operation 1405. The processor 420 may identify whether an air pressure request signal is received from the electronic device while operating in the low-power standby mode.

According to one exemplary embodiment, upon reception of the air pressure request signal while operating in the low-power standby mode, the external device may transition to an active mode to determine whether to transmit the air pressure information of the external device. For example, the external device 401 may identify whether the electronic device which has transmitted the air pressure request signal is authenticated. For example, the external device 401 may identify whether disaster information is included in the air pressure request signal.

According to various exemplary embodiments of the present invention, a method of operating an electronic device includes identifying air pressure of an external device, detecting air pressure of a region in which the electronic device is located, detecting a direction in which the external device is located based on a difference between the air pressure of the external device and the air pressure of the region in which the electronic device is located, and controlling the display to display the direction in which the external device is located.

According to various exemplary embodiments, the identifying of the air pressure of the external device may include determining whether to use the air pressure information based on a valid time, stored in the memory of the electronic device, for the external device, and if it is determined that the air pressure information can be used, detecting air pressure information of the external device from the memory.

According to various exemplary embodiments, the valid time of the air pressure information may be dynamically configured based on a weather of the region in which the electronic device is located.

According to various exemplary embodiments, the method may further include transmitting an air pressure request signal to the external device if it is determined that a usage of the air pressure information is limited, and receiving air pressure information of the external device from the external device in response to the air pressure request signal.

According to various exemplary embodiments, the detecting of the direction in which the external device is located may include, if the air pressure of the external device is lower than the air pressure of the region in which the electronic device is located, determining that the external device is located in an upward direction with respect to the location of the electronic device, and if the air pressure of the external device is higher than the air pressure of the region in which the electronic device is located, determining that the external device is located in a downward direction with respect to the location of the electronic device.

According to various exemplary embodiments, the detecting of the direction in which the external device is located may include determining that, if the difference between the air pressure of the external device and the air pressure of the region in which the electronic device is located is within a reference range, the external device and the electronic device are located in the same floor.

According to various exemplary embodiments, the method may further include, upon detection of a movement of the electronic device, determining a period of detecting a direction of the external device based on a movement speed of the electronic device, upon arrival of the period of detecting the direction of the external device, detecting the air pressure of the region in which the electronic device is located by using the air pressure sensor, detecting the direction in which the external device is located based on the difference between the air pressure of the external device and the air pressure of the region in which the electronic device is located, and updating direction information, displayed on the display, for the direction in which the external device is located based on the direction in which the external device is located.

According to various exemplary embodiments, the method may further include identifying whether pressure information is received from the external device, upon reception of the air pressure information from the external device, detecting the direction in which the external device is located based on the difference between the air pressure received from the external device and the air pressure of the region in which the electronic device is located, and updating direction information, displayed on the display, for the direction in which the external device is located based on the direction in which the external device is located.

According to various exemplary embodiments, the identifying of whether pressure information is received from the external device may include setting an update period for air pressure information of the external device based on weather of the region in which the electronic device is located, upon arrival of the update period, transmitting an air pressure request signal to the external device, and receiving air pressure information from the external device in response to the air pressure request signal.

According to various exemplary embodiments, the external device may include at least one of a vehicle control device and another electronic device.

An electronic device and an operating method thereof according to various exemplary embodiments can output a direction in which an external device is located and which is identified based on an air pressure difference between the external device and the electronic device, thereby allowing a user of the electronic device to easily identify a location of the external device (e.g., a vehicle) with low complexity.

An electronic device and an operating method thereof according to various exemplary embodiments can acquire a direction in which an external device is located based on a valid time for air pressure information of the external device, thereby accurately acquiring a direction in which the external device (e.g., a vehicle) is located.

A term “module” used in the present document includes a unit consisting of hardware, software, or firmware, and may be interchangeably used with a term such as a unit, a logic, a logical block, a component, a circuit, and the like. The “module” may be an integrally constructed component or a minimum unit or one part thereof for performing one or more functions. The “module” may be mechanically or electrically implemented, and may include, for example, an Application-Specific Integrated Circuit (ASIC) chip, a Field-Programmable Gate Arrays (FPGAs), or a programmable-logic device, which is known or to be developed to perform certain operations.

At least one part of an apparatus (e.g., modules or functions thereof) or method (e.g., operations) according to various exemplary embodiments may be implemented with an instruction stored in a computer-readable storage media (e.g., the memory 230 or 430). If the instruction is executed by one or more processors (e.g., the processor 220 or 420), the one or more processors may perform a function corresponding to the instruction. The computer-readable storage media may include a hard disk, a floppy disk, magnetic media (e.g., a magnetic tape), optical media (e.g., a Compact Disc-ROM (CD-ROM), a Digital Versatile Disc (DVD), magnetic-optic media (e.g., a floptical disk)), an internal memory, or the like. The instruction may include a code created by a compiler or a code executable by an interpreter. The module or programming module according to various exemplary embodiments may further include at least one or more constitutional elements among the aforementioned constitutional elements, or may omit some of them, or may further include additional other constitutional elements.

According to various exemplary embodiments, operations performed by a module, programming module, or other constitutional elements may be executed in a sequential, parallel, repetitive, or heuristic manner. At least some of the operations may be executed in a different order or may be omitted, or other operations may be added.

In addition, various exemplary embodiments included in the present document are provided for explaining and understanding technical features, not for limiting the scope of the present invention. Therefore, all changes based on the technical features of the present invention or various other exemplary embodiments will be construed as being included in the scope of the present invention.

Although the present disclosure has been described with an exemplary embodiment, various changes and modifications may be suggested to one skilled in the art. It is intended that the present disclosure encompass such changes and modifications as fall within the scope of the appended claims.

What is claimed is:

1. An electronic device comprising:
an air pressure sensor;
a display; and
a processor configured to:
identify air pressure information of an external device;
identify air pressure of a region that the electronic device is located by using the air pressure sensor;
detect a direction that the external device is located based on a difference between the air pressure information of the external device and the air pressure of the region that the electronic device is located; and
control the display to display the direction that the external device is located.

2. The electronic device of claim 1, further comprising a memory for storing the air pressure information of the external device,
wherein the processor is configured to:
determine whether to use the air pressure information based on a valid time, stored in the memory, for the external device; and
if it is determined that the air pressure information can be used, detect the direction that the external device is located based on a difference between the air pressure information, stored in the memory, for the external device and the air pressure of the region that the electronic device is located.

3. The electronic device of claim 2, wherein the valid time of the air pressure information is dynamically configured based on a weather of the region that the electronic device is located.

4. The electronic device of claim 2, further comprising a communication interface,
wherein the processor is configured to:
control the communication interface to transmit an air pressure request signal to the external device if it is determined that a usage of the air pressure information is limited;
receive air pressure information of the external device from the external device through the communication interface in response to the air pressure request signal; and
detect the direction that the external device is located based on a difference between air pressure information received from the external device for the external device and the air pressure of the region that the electronic device is located.

5. The electronic device of claim 1, wherein the processor is configured to determine that, if the air pressure information of the external device is lower than the air pressure of the region that the electronic device is located, the external device is located in an upward direction with respect to a location of the electronic device, and if the air pressure information of the external device is higher than the air pressure of the region that the electronic device is located, the external device is located in a downward direction with respect to the location of the electronic device.

6. The electronic device of claim 1, wherein the processor is configured to determine that, if the difference between the air pressure information of the external device and the air pressure of the region that the electronic device is located is within a reference range, the external device and the electronic device are located on an equivalent elevation.

7. The electronic device of claim 1, wherein the processor is configured to:
upon detection of a movement of the electronic device, determine a period of detecting a direction of the external device based on a movement speed of the electronic device;
upon arrival of the period of detecting the direction of the external device, detect the air pressure of the region that the electronic device is located by using the air pressure sensor;
detect the direction that the external device is located based on the difference between the air pressure information of the external device and the air pressure of the region that the electronic device is located; and
update direction information, displayed on the display, for the direction that the external device is located based on the direction that the external device is located.

8. The electronic device of claim 1, wherein the processor is configured to:
upon reception of the air pressure information from the external device, detect the direction that the external device is located based on the difference between the identified air pressure information from the external device and the air pressure of the region that the electronic device is located; and
update direction information, displayed on the display, for the direction that the external device is located based on the direction that the external device is located.

9. The electronic device of claim 8, wherein the processor is configured to:
set an update period for air pressure information of the external device based on weather of the region that the electronic device is located;
control a communication interface to transmitting an air pressure request signal to the external device upon arrival of the update period; and
receive air pressure information from the external device in response to the air pressure request signal.

10. The electronic device of claim 1, wherein the external device comprises at least one of a vehicle control device and another electronic device.

11. A method of operating an electronic device, the method comprising:
identifying air pressure information of an external device;
identifying air pressure of a region that the electronic device is located;
detecting a direction that the external device is located based on a difference between the air pressure information of the external device and the air pressure of the region that the electronic device is located; and
displaying the direction that the external device is located.

12. The method of claim 11, wherein the identifying of the air pressure information of the external device comprises:
determining whether to use the air pressure information based on a valid time, stored in a memory of the electronic device, for the external device; and
if it is determined that the air pressure information can be used, detecting air pressure information of the external device from the memory.

13. The method of claim 12, wherein the valid time of the air pressure information is dynamically configured based on a weather of the region that the electronic device is located.

14. The method of claim 12, further comprising:
transmitting an air pressure request signal to the external device if it is determined that a usage of the air pressure information is limited; and
receiving air pressure information of the external device from the external device in response to the air pressure request signal.

15. The method of claim 11, wherein the detecting of the direction that the external device is located comprises:
if the air pressure information of the external device is lower than the air pressure of the region that the electronic device is located, determining that the external device is located in an upward direction with respect to a location of the electronic device, and
if the air pressure information of the external device is higher than the air pressure of the region that the electronic device is located, determining that the external device is located in a downward direction with respect to the location of the electronic device.

16. The method of claim 11, wherein the detecting of the direction that the external device is located comprises determining that, if the difference between the air pressure information of the external device and the air pressure of the region that the electronic device is located is within a reference range, the external device and the electronic device are located on a similar elevation.

17. The method of claim 11, further comprising:
upon detection of a movement of the electronic device, determining a period of detecting a direction of the external device based on a movement speed of the electronic device;
upon arrival of the period of detecting the direction of the external device, detecting the air pressure of the region that the electronic device is located by using an air pressure sensor;
detecting the direction that the external device is located based on the difference between the air pressure information of the external device and the air pressure of the region that the electronic device is located; and
updating direction information, displaying the direction that the external device is located based on the direction that the external device is located.

18. The method of claim 11, further comprising:
identifying whether pressure information is received from the external device;
upon reception of the air pressure information from the external device, detecting the direction that the external device is located based on the difference between the identified air pressure information from the external device and the air pressure of the region that the electronic device is located; and
updating direction information, displaying the direction that the external device is located based on the direction that the external device is located.

19. The method of claim 18, wherein identifying the pressure information is received from the external device comprises:
setting an update period for air pressure information of the external device based on weather of the region that the electronic device is located;
upon arrival of the update period, transmitting an air pressure request signal to the external device; and
receiving air pressure information from the external device in response to the air pressure request signal.

20. The method of claim 11, wherein the external device comprises at least one of a vehicle control device and another electronic device.
